(19) United States
(12) Patent Application Publication
(10) Pub. No.: US 2025/0206282 A1
(43) Pub. Date: Jun. 26, 2025

(54) SERVICE BRAKE VENTILATION UNIT FOR AN OPERATIONALLY RELIABLE PARKING BRAKE ASSEMBLY

(71) Applicant: ZF CV Systems Global GmbH, Bern (CH)

(72) Inventors: Julian van Thiel, Grossburgwedel (DE); Arne Michaelsen, Seelze (DE); Robert Otremba, Ronnenberg (DE)

(21) Appl. No.: 18/979,079

(22) Filed: Dec. 12, 2024

(30) Foreign Application Priority Data
Dec. 22, 2023 (DE) 10 2023 136 451.0

(51) Int. Cl. B60T 13/68; B60T 13/38

(52) U.S. Cl. CPC B60T 13/683; B60T 13/385

(57) ABSTRACT

An electronically controllable pneumatic brake system has a primary service brake pressure modulator, a primary control unit, a secondary control unit that controls the first service brake circuit in the event of a fault, and a secondary service brake pressure modulator connected to the secondary control unit. The secondary service brake pressure modulator is supplied with reservoir pressure and has a secondary working connection for providing a redundancy brake pressure. A parking brake assembly is supplied with reservoir pressure and provides at a parking brake working connection a parking brake pressure for spring brake cylinders. A ventilation valve unit is arranged downstream of the secondary working connection and is connected to the secondary control unit and ventilates the secondary working connection in accordance with a ventilation signal provided by the secondary control unit so as to lower a reservoir pressure in order thereupon to ventilate the spring brake cylinder.

### CROSS-REFERENCE TO RELATED APPLICATIONS

This application claims priority of German patent application no. 10 2023 136 451.0, filed Dec. 22, 2023, the entire content of which is incorporated herein by reference.

### TECHNICAL FIELD

The disclosure relates to an electronically controllable pneumatic brake system for a utility vehicle, having at least one first service brake circuit having a first primary service brake pressure modulator for modulating a first primary service brake pressure at first service brake actuators at a first axle of the utility vehicle; a primary electronic brake control unit that is connected via a vehicle bus to a unit for autonomous driving and receives maneuver-related data therefrom, wherein the primary electronic brake control unit is connected to the first primary service brake pressure modulator and provides first primary switching signals thereto for the purposes of switching at least one electromagnetic valve of the first primary service brake pressure modulator; a secondary electronic brake control unit that is connected via the vehicle bus to the unit for autonomous driving or to a redundant unit for autonomous driving and receives maneuver-related data therefrom and that is provided to control the first service brake circuit at least partially in the event of a fault of the primary electronic brake control unit; a first secondary service brake pressure modulator that is connected to the secondary electronic brake control unit and receives therefrom first secondary switching signals for the purposes of switching at least one electromagnetic valve of the first secondary service brake pressure modulator, wherein the first secondary service brake pressure modulator is supplied with reservoir pressure and has a first secondary working connection for providing a first redundancy brake pressure; and a parking brake assembly including a parking brake valve unit that is supplied with reservoir pressure and provides at a parking brake working connection a parking brake pressure for at least one spring brake cylinder of the utility vehicle. The disclosure also relates to a method for controlling an electronically controllable pneumatic brake system of the above type and to a utility vehicle including an electronically controllable pneumatic brake system of the above type.

### BACKGROUND

Modern utility vehicles commonly have an electropneumatic or electronically controllable pneumatic brake system. Spring brakes in the form of parking brakes are part of the brake system. The parking brakes operate under the action of spring force and can be released by the pressurization of spring brake cylinders and arrested by ventilation of the cylinders. Within a service brake system, valves for regulating the service brake pressure are electronically controlled. The valves may be provided in, or outside, so-called axle modulators. The axle modulators may be automated or partially automated, and/or may be electronically controllable by an autonomous unit. The parking brakes are also electronically controlled. For example, the pressurization or ventilation of the spring brake cylinders can be controlled by actuation of a solenoid valve. The spring brake cylinders may be combined with service brake cylinders, such that the spring brake and service brake act on the same brake pistons. Suitable configuration measures may be implemented in order to avoid mechanical overloading of the brake pistons as a result of summation of braking forces from the service brakes and the spring brakes. If the service brakes are actuated while the parking brakes are active, the spring brake cylinders are simultaneously pressurized in order to thus avoid summation of the braking forces. Such a function is also referred to as an “anti-compound function”.

It must be possible for the parking brake to be engaged by a driver of the vehicle. In some markets, this is performed by way of an electronic parking brake demand to the parking brake device. In other markets, for safety reasons, the spring brake cylinders are ventilated if the reservoir pressure in the service brake system falls. Here, the service brake and parking brake may also be assigned to different brake circuits.

Safety concepts are of high relevance in the case of electropneumatic brake systems for modern vehicles. In particular in vehicles with automated or semi-automated driving functions, brake functions must remain available at least to a restricted extent even in the event of a fault or a power failure of a control unit. Only in this way can the safety of the vehicle, its occupants and other road users be ensured. For this purpose, it is known to provide redundancy levels that can continue to provide an at least restricted braking function even in the event of failure of a primary system.

A redundancy level is also desired for the parking brake, because in most cases, vehicles can be safely parked only with the parking brake engaged. It is also known to use the parking brake as an auxiliary brake or additional brake in situations in which a fault has occurred in the service brake system.

US 2024/0246520 has disclosed a method for operating an electropneumatic brake system for a vehicle, wherein the brake system includes a service brake system and a parking brake system, wherein the parking brake system includes at least one spring brake cylinder. The method is characterized by the steps: providing, via a control unit, a control signal for maintaining a spring accumulator pressurization pressure with which the at least one spring brake cylinder is pressurized, stopping the provision of the control signal in the event of a fault and/or an electrical failure and/or in a diagnostic situation of the control unit, thus automatically ending the maintaining of the spring accumulator pressurization pressure in order to ventilate the at least one spring brake cylinder, thus triggering a spring accumulator failure braking operation:
of the vehicle via the parking brake system, with the spring accumulator pressurization pressure being vented by way of a service brake ventilation function of the service brake system. The service brake ventilation function makes it possible to realize at least one, in particular continuously or intermittently opened, ventilation path in the service brake system for the purposes of ventilating the at least one spring brake cylinder. The service brake ventilation function is implemented in particular via a valve in the service brake system, preferably an outlet valve and/or a further outlet valve.

Further partially redundant systems are known from US 2024/0375628, US 204/0198991, US 2024/0182011, US 2023/0311828 and US 2017/0072930.

Even though redundant options for engaging a parking brake have already been created by known systems, there is a demand for further improvements. In particular, in the prior art, in driver-controlled vehicles, so-called “pumping-down” is applied, where the driver actuates the service brake multiple times. This greatly increases air consumption, with the aim of lowering the pressure level to such an extent that the spring brake cylinders of the vehicle consequently engage.

However, one problem is, on the one hand, to increase the air consumption sufficiently, while on the other hand, in the case of vehicles with higher levels of automation (SAE level 4 or 5), a driver who could intervene manually in this way is not always present.

### SUMMARY

It is therefore desirable to improve the engagement of a parking brake. In particular, the ventilation of at least one spring brake cylinder in a reliable manner and with low effort is to be made possible.

It is an object of the disclosure to provide an improved electronically controllable pneumatic brake system in which the ventilation of a spring brake cylinder is made possible in a simple and/or reliable manner even in the case of redundancy.

Accordingly, in an electronically controllable pneumatic brake system of the type mentioned at the beginning, there is provided a first ventilation valve unit that is arranged downstream of the first secondary working connection and is connected to the secondary electronic brake control unit and that is provided to ventilate the first secondary working connection into the surroundings in accordance with at least one first ventilation signal provided by the secondary electronic brake control unit so as to lower the reservoir pressure level, in order thereupon to ventilate the spring brake cylinder. Preferably, the reservoir pressure level is lowered to such an extent that the at least one spring brake cylinder engages and thus brakes the vehicle. Spring brake cylinders are usually constructed in such a manner that, owing to the spring force, below a certain pressure level they overcome that pressure and engage. The disclosure thus proposes providing, instead of manual pumping-down by the driver of a vehicle, a ventilation valve unit which, in accordance with a signal, which here is preferably provided by the secondary electronic brake control unit, increases the air consumption of the brake system, preferably of the secondary brake system, such that the spring brake cylinders engage. This can be provided in particular for the case in which the primary electronic brake control unit is not functioning or is not functioning correctly or another relevant system is not functioning or is no longer functioning correctly, such that, as a result, the corresponding signal for the ventilation valve unit is provided so as to safely brake the vehicle.

It should be understood that the electronically controllable pneumatic brake system described herein may have not only the at least one first service brake circuit but also at least one second service brake circuit. For example, the first service brake circuit is a rear-axle brake circuit, whereas a second service brake circuit is a front-axle brake circuit. Further brake circuits such as a trailer brake circuit, or further brake circuits for further axles, may also be provided. It is also conceivable for brake circuits not to be distributed according to axles, but to encompass other subassemblies of the brake system, for example the left-hand and right-hand sides of the vehicle. In this respect, in addition to the first primary service brake pressure modulator, it is typically the case that a second primary service brake pressure modulator is provided in the electronically controllable pneumatic brake system and controls one, or the second, axle. Preferably, the primary electronic brake control unit is connected to the second primary service brake pressure modulator and provides second primary switching signals thereto for the purposes of switching at least one electromagnetic valve of the second primary service brake pressure modulator.

Additionally, a primary level and at least one secondary level are provided, wherein one or more valves or one or more modulators may be structurally assigned to both the primary and the secondary level. The primary level is controlled by the primary electronic brake control unit, whereas the secondary level is controlled by the secondary electronic brake control unit. The electronically controllable pneumatic brake system is preferably operated in the secondary level if, in the primary level, one or more faults occur which partially or entirely prevent a service brake pressure from being modulated normally in the primary level.

The ventilation valve unit ventilates the first secondary working connection preferably directly into the surroundings without the interposition of one or more switchable valves. Ventilation directly into the surroundings is understood to be performed even if, for example, a line and/or a silencer and/or a reed valve are provided. By contrast, ventilation is performed not directly if one or more further (switchable) valves, which may also block the ventilation, are provided.

In a first embodiment there is provided a second secondary service brake pressure modulator that has a second secondary working connection for providing a second redundancy brake pressure. In this embodiment, it is preferably further provided that the electronically controllable pneumatic brake system has a second ventilation valve unit that is arranged downstream of the second secondary working connection and is connected to the secondary electronic brake control unit or to a further electronic control unit and that is provided to ventilate the second secondary working connection into the surroundings in accordance with at least one second ventilation signal.

The first and second ventilation valve units may be structurally identical, but may also be of different forms. Both the first and the second ventilation signal may be both the presence and the absence of electric current. In this respect, the loss of an electrical signal, that is, the change from a 1 to a 0 signal, is also a ventilation signal within the context of the disclosure described herein.

Both the first and the second secondary working connection may be connected to one or more service brake actuators, at which the first or second redundancy brake pressure, respectively, is then received.

Furthermore, it can be preferred for a first voltage source to be provided for the purposes of supplying electrical power to the primary electronic brake control unit. A second voltage source is preferably also provided for the purposes of providing a supply to the secondary electronic brake control unit. The first and second voltage sources are preferably independent of one another, such that a failure of the first voltage source does not lead to a failure of the second voltage source, and vice versa.

In an embodiment, it is provided that the primary electronic brake control unit is combined with the first primary service brake pressure modulator as a module to form a structural unit. Such a module may also be referred to as a central module or primary central module. Preferably, the secondary electronic brake control unit is combined with the first secondary service brake pressure modulator and/or with the second secondary service brake pressure modulator as a module to form a structural unit. Such a module may also be referred to as a secondary or redundant central module. Preferably, the first primary service brake pressure modulator and/or the first secondary service brake pressure modulator are two-channel axle modulators which are able to modulate independent service brake pressures at first and second channels.

In a further embodiment, the first ventilation valve unit is combined with the first secondary service brake pressure modulator as a module to form a structural unit. For example, the first ventilation valve unit may be integrated in the first secondary service brake pressure modulator. If this is in the form of a secondary central module, the first ventilation valve unit may also be integrated in the secondary central module.

The second ventilation valve unit, where present, may also be combined with the secondary service brake pressure modulator as a module to form a structural unit. If the secondary service brake pressure modulator is in the form of a secondary central module, the second ventilation valve unit may also be integrated in the secondary central module.

Preferably, the electronically controllable pneumatic brake system can have at least one first compressed-air reservoir that supplies the first primary service brake pressure modulator with reservoir pressure. Preferably, the first compressed-air reservoir also supplies the first secondary service brake pressure modulator with reservoir pressure. If, for example, the first primary service brake pressure modulator and the first secondary service brake pressure modulator are assigned to a rear-axle brake circuit (for example, first brake circuit), the first compressed-air reservoir supplies the rear-axle brake circuit. In such an embodiment, the first ventilation valve unit then serves to lower the pressure level in the first brake circuit and thus in the first compressed-air reservoir.

Preferably, the electronically controllable pneumatic brake system has at least one second compressed-air reservoir that is likewise able to supply the first secondary service brake pressure modulator with reservoir pressure. Alternatively and preferably, the second compressed-air reservoir supplies a second secondary service brake pressure modulator and/or a second primary service brake pressure modulator. For example, a second primary service brake pressure modulator is assigned to a second brake circuit, which may be, for example, a front-axle brake circuit. Here, a second secondary service brake pressure modulator is preferably also provided and is provided to replace the second primary service brake pressure modulator partially or entirely in the event of a fault in the second brake circuit. The second ventilation valve unit then serves in this case to reduce the pressure level in the second brake circuit and thus also to ventilate the second compressed-air reservoir.

A supply is provided to the parking brake valve unit preferably at least from the first compressed-air reservoir or the second compressed-air reservoir, or from a third compressed-air reservoir, but preferably from both the first and the second compressed-air reservoir. For this purpose, the parking brake assembly may have a push-pull valve or select-high valve which pressure-transmittingly connects both the first and the second compressed-air reservoir to the spring brake cylinders. It is alternatively also conceivable for the parking brake unit to be supplied with reservoir pressure directly from an air treatment unit. In particular in the case of electronically controllable pneumatic brake systems such as are used in North America, Canada or also in some other regions of the world, it is common for a supply to be provided to spring brake cylinders of a parking brake assembly from two compressed-air reservoirs, in particular the first and second compressed-air reservoirs that are provided for a front-axle brake circuit and a rear-axle brake circuit.

According to a further embodiment, it is provided that the first secondary working connection is connected or is able to be connected to a first redundancy connection of the first primary service brake pressure modulator or to a second redundancy connection of a or the second primary service brake pressure modulator.

Preferably, the second secondary working connection is connected or is able to be connected to a second redundancy connection of the second primary service brake pressure modulator. A first or second redundancy connection is here understood as being a connection of a modulator or of a valve assembly, via which a redundant control pressure can be received and via which a relay valve of the corresponding modulator can then preferably be pressurized in order thus to modulate a pressure that is otherwise modulated electronically in the primary level purely pneumatically and thus redundantly. For example, instead of being received otherwise by an inlet-outlet valve combination that is electromagnetically switchable and provides a control pressure, this control pressure is received via the redundancy connection and then provided in an otherwise identical manner to a relay piston of a relay valve. Redundancy connections may generally be provided with, for example, a redundancy valve which in normal operation shuts off the redundancy connection and frees the redundancy connection only in the event of a fault.

According to a further embodiment, the first ventilation valve unit has an electromagnetic ventilation switching valve that is connected via a branch to a line leading from the first secondary working connection and that has at least one shut-off position and one passage position, wherein in the energized state it is switchable into the passage position and in the deenergized state is in the shut-off position, and wherein the first secondary working connection is ventilated in the passage position. The electromagnetic ventilation switching valve is preferably a 2/2-way valve. In this way, particularly simple ventilation of the first secondary working connection is provided. The first ventilation switching valve preferably has a sufficiently large nominal width to effect rapid and effective ventilation of the first secondary working connection. In a corresponding manner, the second ventilation valve unit may also have a second electromagnetic ventilation switching valve that is connected via a branch to a line leading from the second secondary working connection and that has at least one shut-off position and one passage position, wherein in the energized state it is switchable into the passage position and in the deenergized state is in the shut-off position, and wherein the second secondary working connection is ventilated in the passage position. As a result of the first and second ventilation switching valves being in the shut-off position in the energized state, a safety function is implemented which has the result that the spring brake cylinders do not automatically engage in a deenergized case. The first and second ventilation switching valves preferably have a nominal width in a range of from 5 to 7 mm.

In a further embodiment, the first ventilation valve unit has an ABS valve unit. ABS valve units, as they are generally known in the prior art, can advantageously be used to ventilate a specific compressed-air path rapidly and with a short reaction time. In this respect, conventionally known ABS valves are particularly suitable for ventilating also the first secondary working connection or second secondary working connection.

Here, it may be provided that the ABS valve unit has a pneumatically switchable inlet valve, a pneumatically switchable outlet valve, an electromagnetic inlet valve, and an electromagnetic outlet valve. According to a further embodiment, the first ventilation valve unit has an electromagnetic ventilation switching valve inserted into a line leading from the first secondary working connection. In a corresponding manner, the second ventilation valve unit may also have a second electromagnetic ventilation switching valve inserted into a line leading from the second secondary working connection. While the above-mentioned ventilation switching valves that are preferably configured as 2/2-way valves are inserted into lines that branch from the line leading from the working connection, that is, are arranged in parallel in terms of switching, the electromagnetic ventilation switching valves mentioned here are connected in series with the first and second secondary working connections.

Here, it may be provided that the electromagnetic ventilation switching valve has a passage position and a ventilation position, wherein in the deenergized state it is in the passage position and connects the first secondary working connection to a line leading to a functional unit and in the energized state is in the ventilation position, in which the first secondary working connection is ventilated. The functional unit mentioned here is preferably the first primary service brake pressure modulator, more precisely the redundancy connection of the first primary service brake pressure modulator.

In a second aspect, the object mentioned at the beginning is achieved by a method for controlling an electronically controllable pneumatic brake system, preferably an electronically controllable pneumatic brake system of an above-described embodiment of an electronically controllable pneumatic brake system according to the first aspect of the disclosure. The method according to the second aspect of the disclosure preferably includes the steps: determining a fault that prevents a parking brake function of the electronically controllable pneumatic brake system from being actuated by ventilation of spring brake cylinders by switching of at least one electromagnetic valve of a parking brake valve unit; outputting an electrical ventilation signal by a secondary electronic brake control unit to a first ventilation valve unit for the purposes of ventilating a first secondary working connection into the surroundings so as to lower a reservoir pressure level, and thereupon ventilating the spring brake cylinders.

It should be understood that the electronically controllable pneumatic brake system according to the first aspect of the disclosure and the method according to the second aspect of the disclosure have the same and similar sub-aspects. In this respect, for preferred refinements of the method, reference is also made to the entirety of the above description.

The method preferably includes the step: modulating a first redundancy brake pressure at the first secondary working connection at the instigation of the secondary electronic brake control unit. The first secondary working connection is preferably a working connection of the first secondary service brake pressure modulator that is controlled by the secondary electronic brake control unit. The first redundancy brake pressure modulated by the first secondary brake pressure modulator is ventilated into the surroundings via the ventilation unit switched in the event of a fault, so that increased air consumption is achieved via the first secondary service brake pressure modulator.

Furthermore, the method preferably further includes the steps: increasing a pressure in one or a plurality of service brake cylinders; and maintaining the increased pressure in the one or the plurality of service brake cylinders. These steps are preferably carried out only if the fault pattern permits it. By maintaining the pressure, it is preferably ensured that the remaining or increased pressure in the service brake cylinders remains and the cylinders remain partially or completely engaged. These steps are preferably carried out in the case of falling or low reservoir pressure. An advantage associated therewith is that the vehicle is still secured against rolling away even in the case of falling reservoir pressure. The pressure increase in the service brake cylinders is preferably carried out because no further readjustment can take place in the service brake part during the following “pumping-out”, but relatively small leaks could lead to a pressure drop in the service brake cylinders.

In a third aspect of the disclosure, the object mentioned at the beginning is achieved by a utility vehicle having at least one front axle, at least one rear axle, and an electronically controllable pneumatic brake system according to one of the above-described embodiments of an electronically controllable pneumatic brake system according to the first aspect of the disclosure.

### BRIEF DESCRIPTION OF DRAWINGS

The invention will now be described with reference to the drawings wherein:

FIG. 1 is a schematic illustration of an electronically controllable pneumatic brake system according to the disclosure in the form of a block diagram;

FIG. 2 shows a more detailed layout of an electronically controllable pneumatic brake system of an embodiment according to the disclosure;

FIG. 3 shows a first embodiment of a ventilation valve unit;

FIG. 4 shows a second embodiment of a ventilation valve unit; and,

FIG. 5 shows a third embodiment of a ventilation valve unit.

### DETAILED DESCRIPTION

An electronically controllable pneumatic brake system 200 has an operational level 200a and at least one first redundancy level 200b. In the operational level 200a, the electronically controllable pneumatic brake system 200 includes a primary system 212 having a primary electronic control unit 214 that controls the electronically controllable pneumatic brake system 200 in the operational level 200a. The primary electronic control unit 214 is connected via an electronic connection, in this case a vehicle bus 216, to a unit for autonomous driving 218, here specifically a primary unit for autonomous driving 218a, and from this receives maneuver-related data, such as braking demand signals SA. The primary unit for autonomous driving 218a, like a secondary unit for autonomous driving 218b, may be represented as entities in the unit for autonomous driving 218. Furthermore, the primary electronic brake control unit 214 is connected via a first supply line 220 to a first voltage source 222 and is supplied with electrical power therefrom. The primary electronic brake control unit 214 converts the braking demand signals SA and, on the basis thereof, outputs first primary switching signals, for example in the form of service brake signals SB, to a first primary service brake pressure modulator 224. The first primary service brake pressure modulator 224 is provided, for example, for a rear axle HA, and can thus also be referred to as primary rear-axle service brake pressure modulator or primary rear-axle modulator.

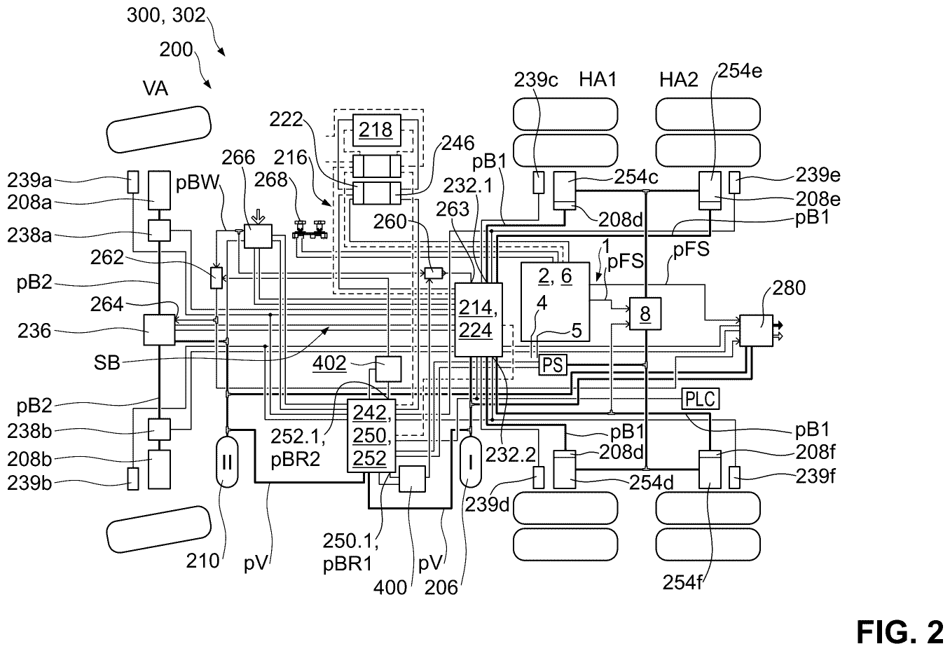

The first primary service brake pressure modulator 224 is connected to a first compressed-air reservoir 206 and receives reservoir pressure pV therefrom. On the basis of the received service brake signals SB, the first primary service brake pressure modulator 224 modulates a first service brake pressure pB1 at least at one first service brake pressure connection 232.1 and preferably one second service brake connection 232.2 (see FIG. 2). The first service brake pressure pB1 is preferably modulated on a wheel-specific basis at the first and second service brake pressure connections 232.1, 232.2, and the first primary service brake pressure modulator 224 is configured as a two-channel modulator. In other embodiments, the first service brake pressure connection 232.1 and the second service brake pressure connection 232.2 may however also be combined, and the first primary service brake pressure modulator 224 may thus be configured as a single-channel axle modulator, which modulates the first service brake pressure pB1 on an axle-specific basis.

In order to brake at least one further axle, the electronically controllable pneumatic brake system 200 includes, in the operational level 200a, a second primary service brake pressure modulator 236, which is for example provided for a front axle VA and which can thus also be referred to as front-axle modulator. The second primary service brake pressure modulator 236 receives reservoir pressure pV from a second compressed-air reservoir 210 and modulates a second brake pressure pB2 on an axle-specific basis, a side-specific basis or a wheel-specific basis at least at one third service brake pressure connection 236.1 and preferably one fourth service brake pressure connection 236.2 (see FIG. 2). The second primary service brake pressure modulator 236 may also be configured as a single-channel or two-channel axle modulator, and is preferably configured as a two-channel axle modulator.

In the redundancy level, the electronically controllable pneumatic brake system 200 includes a secondary electronic brake control unit 242 of a secondary or redundancy system 241, which is provided for controlling the electronically controllable pneumatic brake system 200 in the event that the operational level 200a has one or more faults. The secondary electronic brake control unit 242 can thus control the electronically controllable pneumatic brake system 200 for example in the event of an electrical failure in the first voltage source 222, an electronic fault in the primary electronic brake control unit 214, or the like.

The secondary electronic brake control unit 242 is likewise connected via the vehicle bus 216 to the unit for autonomous driving 218, here to the secondary unit for autonomous driving 218b, and likewise receives therefrom maneuver-related data, for example braking demand signals SA or redundant braking demand signals SA-R. In contrast to the primary electronic brake control unit 214, the secondary electronic brake control unit 242 is connected via a second supply line 244 to a second voltage source 246 and is supplied with electrical power therefrom. The first and the second voltage sources 222, 246 are independent of one another, such that a failure in the first voltage source 222 does not lead to a loss of the second voltage source 246, and vice versa. The primary electronic brake control unit 214 and the secondary electronic brake control unit 242 are thus electrically independent of one another.

To be able to exchange signals, the primary electronic brake control unit 214 and the secondary electronic brake control unit 242 are connected to one another via a redundancy bus 248 (see FIG. 2). In this way, the secondary electronic brake control unit 242 can determine the availability of the primary electronic brake control unit 214, and perform the control of the electronically controllable pneumatic brake system 200 only if the primary electronic brake control unit 214 is not available or not properly available. In variants, however, communication between the primary electronic brake control unit 214 and the secondary electronic brake control unit 242 may for example also take place via the vehicle bus 216.

In the redundancy level 200b, a first secondary service brake pressure modulator 250 is provided which is connected to the secondary electronic brake control unit 242 and which receives secondary switching signals therefrom, for example in the form of redundancy brake signals SR. In the embodiment according to FIG. 2, which is to be described in greater detail, the secondary electronic brake control unit 242 is integrated in the first secondary service brake pressure modulator 250. In other variants, the secondary electronic brake control unit 242 and the first secondary service brake pressure modulator 250 may however also be physically separate units. The first secondary service brake pressure modulator 250 is connected to the first compressed-air reservoir 206, which is independent of the second compressed-air reservoir 210, such that the first compressed-air reservoir 206 can provide reservoir pressure pV even if the second compressed-air reservoir 210 has failed. In other embodiments, the first secondary service brake pressure modulator 250 may however also be connected to the first compressed-air reservoir 206 or to both the first compressed-air reservoir 206 and the second compressed-air reservoir 210, or even provided with a supply from a third compressed-air reservoir.

The first secondary service brake pressure modulator 250 modulates a first redundancy brake pressure pBR1 at a first secondary working connection 250.1 in accordance with the redundancy brake signal SR. Via the first redundancy brake pressure pBR1, the first axle, preferably the rear axle, can be braked redundantly, and thus in the secondary level 200b. This may be implemented on an axle-specific basis or on a wheel-specific basis.

In the embodiment shown here, a second secondary service brake pressure modulator 252 is also provided, which is provided in particular for replacing the second primary service brake pressure modulator 236. The second secondary service brake pressure modulator 252, like the first secondary service brake pressure modulator 250, receives the redundancy brake signal or signals SR and modulates a second redundancy brake pressure pBR2 at a second redundancy brake pressure connection 252.1 in accordance with the signals.

As will be explained in greater detail with reference to FIG. 2, the brake actuators assigned to the wheels of the rear axles HA1, HA2 are configured here as double-acting brake actuators, also referred to as Tristop cylinders. Aside from the service brake actuators 208c-208f, these each also include a spring brake cylinder 254c-254f. The spring brake cylinders 254c-254f are configured to apply the brakes of the vehicle 300 when unpressurized or ventilated. The spring brake cylinders 254c-254f can advantageously be utilized as parking brakes, because no compressed air needs to be provided in order to brake the rear axles HA1, HA2. To release the rear wheels, the spring brake cylinders 254c-254f must be pressurized with a parking brake pressure pFS. This parking brake pressure pFS acts counter to the spring accumulators and releases the brakes of the vehicle 300.

To provide the parking brake function, the brake system 200 includes a parking brake assembly 1. The parking brake assembly includes an electropneumatic parking brake valve unit 2 which is supplied via a first reservoir connection 4 with reservoir pressure pV from the first compressed-air reservoir 206 and via a second reservoir connection 5 with reservoir pressure pV from the second compressed-air reservoir 210. It would however also be possible for reservoir pressure to be supplied to the parking brake valve unit 2 only from one of the two compressed-air reservoirs 206, 210 or from a third compressed-air reservoir or directly from an air treatment unit.

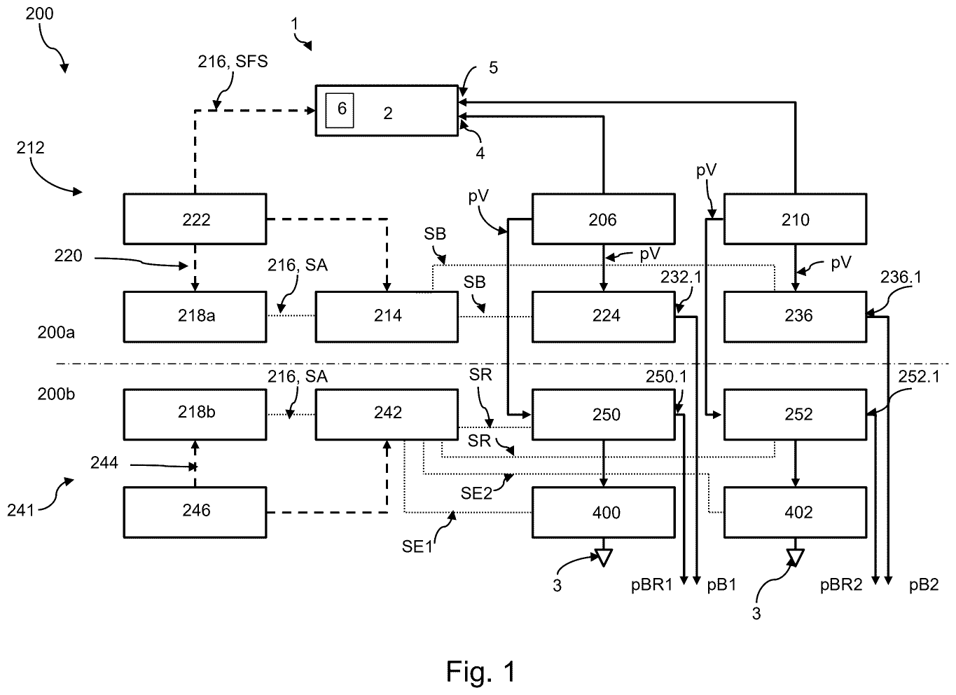

The electropneumatic parking brake valve unit 2 includes a parking brake control unit 6 that is connected via the vehicle bus 216 to the unit for autonomous driving 218. To engage the parking brake, the unit for autonomous driving 218 provides a parking brake signal SFS to the parking brake control unit 6 via the vehicle bus 216, and the parking brake control unit thereupon provides the parking brake pressure pFS at a first spring accumulator connection 8a and at a second spring accumulator connection 8b (not shown in FIG. 1, see FIG. 2). In FIG. 2, the first spring accumulator connection 8a is connected to the spring brake cylinders 254d, 254f, and the second spring accumulator connection 8b is connected to the spring brake cylinders 254c, 254e. By providing the parking brake pressure pFS, the electropneumatic parking brake valve unit 2 pressurizes the spring brake cylinders 254c-254f and thus releases the parking brake. To engage the parking brake of the vehicle 300, the electropneumatic parking brake valve unit 2 can ventilate the spring accumulator connections 8a, 8b and the spring brake cylinders 254c-254f connected thereto. This may be performed in response to corresponding second parking brake signals being received at the parking brake control unit 6, or when parking brake signals SFS are no longer being provided by the parking brake control unit 6.

In the event that a fault occurs in the brake system which prevents the parking brake from being engaged or makes it necessary for the parking brake to be engaged redundantly, for example so as to safely stop the vehicle 300 in place of a service brake that is not functioning or not functioning correctly, the disclosure provides at least one first ventilation valve unit 400 that is arranged downstream of the first secondary working connection 250.1 and is connected to the secondary electronic brake control unit 242 and that is provided to ventilate the first secondary working connection 250.1 into the surroundings in accordance with at least one first ventilation signal SE1 provided by the secondary electronic brake control unit 242. In this way, air consumption in the brake system 200 is increased, specifically by increasing the air consumption in the secondary level 200b. In the embodiment shown in FIG. 1, the arrangement is only schematic and, even though the first ventilation valve unit 400 is shown in the drawing as being parallel to the path of the first redundancy brake pressure pBR1, it should be understood that the first ventilation valve unit 400 is actually arranged downstream thereof, specifically for example in that, in the interior of a module (not shown in detail here), the lines are connected such that the first secondary working connection 250 can be ventilated via the first ventilation valve unit 400. The first ventilation valve unit 400 has for this purpose a vent 3, which here opens directly into the surroundings.

It is further apparent from FIG. 1 that, in the embodiment shown therein, only the reservoir pressure level of the first compressed-air reservoir 206 can be reduced via the first ventilation valve unit 400, but not that of the second compressed-air reservoir 210. However, there may be embodiments in which this alone already leads to the spring brake cylinders 254c-254f being engaged. In the embodiment shown in FIG. 1, it is additionally provided that a second ventilation valve unit 402 is arranged downstream of the second secondary working connection 252.1 of the second secondary service brake pressure modulator 252, so as to ventilate the service brake pressure modulator. For this purpose, the second ventilation valve unit 402 also has a vent 3, which here opens directly into the surroundings. There is supplied to the ventilation valve unit 402 for the purposes of switching a second ventilation valve switching signal SE2, which here likewise comes from the secondary electronic brake control unit 242 but could also come from a different electronic control unit of the electronically controllable pneumatic brake system 200.

It should further be understood that the embodiment shown in FIG. 1 is merely schematic and illustrates the electronically controllable pneumatic brake system 200 via functional blocks, but in practice the blocks may optionally be integrated and may be combined to form different modules. In this respect, solid lines around the individual elements do not necessarily indicate a separate housing, although this may be provided in some cases.

FIG. 2 illustrates a concrete embodiment of the electronically controllable pneumatic brake system 200. Identical and similar elements are denoted by the same reference signs, such that reference is made to the above description in its entirety.

In the embodiment illustrated in FIG. 2, the electronically controllable pneumatic brake system 200 is provided for a vehicle 300, specifically a utility vehicle 302, which includes in addition to a front axle VA also a first rear axle HA1 and a second rear axle HA2. However, it should be understood that the electronically controllable pneumatic brake system 200 is equally applicable to vehicles which have only one rear axle or even two front axles or three or more rear axles.

The first compressed-air reservoir 206 is provided in this case for a first brake circuit, which corresponds to a rear-axle brake circuit. The second compressed-air reservoir 210 is provided for a second brake circuit, which corresponds to a front-axle brake circuit. Here, the electronically controllable pneumatic brake system has a total of six service brake actuators, specifically first and second service brake actuators 208a, 208b at the front axle VA, and third, fourth, fifth and sixth service brake actuators 208c-208f at the first and second rear axles HA1, HA2. The service brake actuators 208c-208f at the rear axles HA1, HA2 are combined with the spring brake cylinders 254c-254f to form so-called Tristop cylinders.

The primary electronic brake control unit 214 is combined with the first primary service brake pressure modulator to form a module and is illustrated as a structural unit. The module may also be referred to as a (primary) central module and has the function of both the primary electronic brake control unit 214 and a primary rear-axle modulator, which in this case modulates the first service brake pressure pB1 at the first service brake pressure connection 232.1 and the second service brake pressure connection 232.2 on a side-specific basis. This means that both the first and the second rear axle HA1, HA2 are braked equally, but a separate pressure is modulated on the left and on the right for the vehicle 300. The primary electronic brake control unit 214 or the central module is connected via an electrical line to the second primary service brake pressure modulator 236, which is configured here as a primary front-axle modulator. In the embodiment shown here, the second primary service brake pressure modulator 236 does not have any inherent intelligence, with the electromagnetic valves that are provided there in a known manner being switched directly by the primary electronic brake control unit 214 via the service brake signals SB. Depending on the service brake signals SB, a second service brake pressure pB1 is modulated at the front axle VA on an axle-specific basis, because the second primary service brake pressure modulator 236 is configured here as a single-channel modulator. To achieve a wheel-specific braking action, the electronically controllable pneumatic brake system 200 in the embodiment shown here has first and second ABS valves 238a, 238b, which are controlled in a known manner by the primary electronic brake control unit 214. For this purpose, the primary electronic brake control unit 214 also receives wheel rotational speed signals from first and second wheel rotational speed sensors 239a, 239b at the front axle VA. Wheel rotational speed sensors 239c, 239d, 239e, 239f are also provided at the first and second rear axles HA1, HA2. All of the wheel rotational speed sensors 239a-239f have a direct wired connection to the primary electronic brake control unit 214 and provide wheel rotational speed signals thereto. The primary electronic brake control unit 214 is connected, as described in relation to FIG. 1, via the vehicle bus 216 to the unit for autonomous driving 218.

The primary electronic brake control unit 214 and the first primary service brake pressure modulator 224, that is, the central module as a whole, is supplied with electrical energy by the first voltage source 222. During normal operation, the primary electronic brake control unit 214 receives maneuver-related data, in particular braking demand signals, trajectory data and the like, from the unit for autonomous driving 218, and from these determines the service brake pressure that is to be provided in each case for individual axles or wheels. At the first and second rear axles HA1, HA2, the central module may correspondingly modulate the first service brake pressure pB1 directly; at the front axle VA, the central module provides the brake signals SB to the second primary service brake pressure modulator 236 in order to correspondingly switch valves and modulate the second service brake pressure pB2 there. If wheel slip then occurs, the central module can react directly at the rear axles HA1, HA2 and can switch the first and second ABS valves 238a, 238b at the front axle VA.

The secondary electronic brake control unit 242 is provided as a first redundancy level in the secondary system 241. The secondary electronic brake control unit 242 is combined here both with the first secondary service brake pressure modulator 250 and with the second secondary service brake pressure modulator 252 to form a module, which may be referred to as a secondary or redundant central module. While the (primary) central module including the primary electronic brake control unit 214 and the first primary service brake pressure modulator 224 is supplied with reservoir pressure pV only from the first compressed-air reservoir 206, because the central module controls only the rear-axle brake circuit, the redundant central module including the secondary electronic brake control unit 242, the first secondary service brake pressure modulator 250 and the second secondary service brake pressure modulator 252 is also connected to the second compressed-air reservoir 210, because the redundant central module also controls the front axle VA.

The redundant central module is likewise connected via the vehicle bus 216 to a unit for autonomous driving 218 (for example to the second entity 218b), and receives similar maneuver-related data, trajectory data or the like from the unit for autonomous driving 218. If the central module is not functioning or is not functioning correctly, the redundant central module can take over the control of the brake system 200.

This is provided in the embodiment shown here as follows: The first redundancy brake pressure pBR1, which here is a control pressure, is modulated at a first secondary working connection 250.1. The first redundancy brake pressure pBR1 is provided for the first and second rear axles HA1, HA2. Downstream of the first secondary working connection 250.1 there is arranged first the above-described first ventilation valve unit 400, then the first redundancy brake pressure pBR1 that is generally transmitted by the ventilation valve unit is provided via a first shuttle valve, preferably a select-high valve 260, to a first redundancy connection 263 of the first primary service brake pressure modulator 224, via which the first service brake pressure pB1 can be redundantly modulated in the event that the primary electronic brake control unit 214 is deenergized and thus the first primary service brake pressure modulator 224 is also deenergized. The first primary service brake pressure modulator 224 is capable of implementing the received first redundancy brake pressure pBR1 purely pneumatically, for example by feeding it to a relay valve control piston, and, in dependence thereon, of redundantly modulating the first service brake pressure pB1. The redundant central module likewise modulates at a second secondary working connection 252.1 of the second secondary service brake pressure modulator 252 a second redundancy brake pressure pBA2, which here is first provided to the second ventilation valve unit 402 and is then normally transmitted by the second ventilation valve unit and provided via a second select-high valve 262 to a second redundancy connection 264 of the second primary service brake pressure modulator 236. The second primary service brake pressure modulator is then capable of implementing the second redundancy brake pressure pBR2 purely pneumatically and thus modulating the second service brake pressure pB2 purely pneumatically and redundantly.

In the electronically controllable pneumatic brake system 200 shown here, a second redundancy level or human redundancy level is also provided, in which a driver must take action. For this purpose, a braking value transmitter 266 is provided, though this may also be omitted in the case of higher levels of automation. The braking value transmitter 266 is electrically connected both to the primary electronic brake control unit 214 and to the secondary electronic brake control unit 242 and can provide braking value transmitter signals thereto, such that these two electronic control units can also be capable of implementing braking demands that are input manually by a vehicle driver via the braking value transmitter 266. The braking value transmitter 266 is however also connected to the second compressed-air reservoir 210, and receives reservoir pressure pV from the second compressed-air reservoir 210. Actuation of a brake pedal of the braking value transmitter 266 causes a pneumatic braking value transmitter brake pressure pBW to be modulated, which is then likewise provided to the first and second select-high valves 260, 262 such that it can be provided, alternatively to the first and second redundancy brake pressures pBR1, pBR2, at the corresponding first and second redundancy connections 263, 264. That is, if the electronically controllable pneumatic brake system 200 is deenergized but the first and second compressed-air reservoirs 206, 210 are still adequately full, a purely pneumatic and manually modulated braking action can be achieved via the braking value transmitter 266.

The parking brake assembly 1 is implemented in FIG. 2 in principle as shown in FIG. 1. It has a parking brake valve unit 2 and a parking brake control unit 6, wherein the parking brake control unit 6 is connected via the vehicle bus 216 to the unit for autonomous driving 218 and is able to receive therefrom for example parking brake signals. However, the primary electronic control unit 214 could also demand such parking brake signals via the vehicle bus 216, for example in order to park the vehicle 300 or use the parking brake 1 as an additional brake or auxiliary brake. Furthermore, the parking brake assembly 1 is connected to a so-called push-pull valve 268, via which, in the embodiment shown here, a demand for ventilating the spring brake cylinders 254c-254f can also be made by a driver by electrical means. For this purpose, the push-pull valve 268 is also electrically connected to the parking brake control unit 6.

In the embodiment shown, the parking brake assembly 1 includes a relay valve 8, which is illustrated here as being separate and which receives the parking brake pressure pFS, or a parking brake control pressure derived therefrom, from the parking brake valve unit 2. The relay valve 8 can then boost the volume of this pressure and correspondingly transmit same to the spring brake cylinders 254c-254f. For this purpose, the relay valve 8 can additionally be connected to the first and second compressed-air reservoirs 206, 210. The first service brake pressure pB1 is also provided to the relay valve 8 in order to thus be able to implement an anti-compound function.

If the first and second ventilation valve units 400, 402 are then switched, as described with reference to FIG. 1, such that the first secondary working connection 250.1 and the second secondary working connection 252.1 are ventilated, the compressed-air consumption in the redundancy level is increased such that the reservoir pressure level falls. Since this relates to both the first and the second compressed-air reservoirs 206, 210, the reservoir pressure level decreases overall, such that, when a particular threshold is undershot, the spring force provided in the spring brake cylinders 254c-254f exceeds the opposing force built up by the parking brake pressure pFS, and the spring brake cylinders 254c-254f thus engage and brake the vehicle 300.

In the embodiment shown here, a trailer control valve 280 is also provided, which in a known manner has a red and a blue or yellow coupling head and which is likewise connected to the first and the second compressed-air reservoirs 206, 210. The trailer control valve 280 is electrically controlled directly from the primary electronic brake control unit 214 and need not necessarily have inherent intelligence. It may also be purely pneumatically controlled from the front-axle brake circuit, and for this purpose is also connected to the second select-high valve 262, specifically to an outlet of the second select-high valve 262, in order to thus receive the second redundancy brake pressure pBR2 or braking value transmitter pressure pBW in order to likewise redundantly brake the trailer. To implement a parking brake function in the trailer, the trailer control valve 280 is also connected to the parking brake assembly 1 and can for example receive parking brake pressure pFS therefrom.

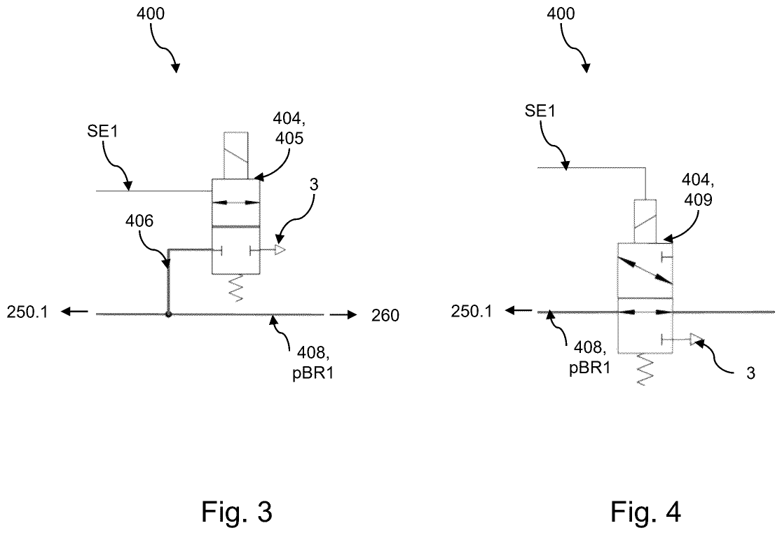

FIGS. 3 to 4 show three different embodiments of a first or second ventilation valve unit 400, 402. Although FIGS. 3 to 5 are described only with reference to the first ventilation valve unit 400, it should be understood that the second ventilation valve unit 402 may be formed identically.

In a first embodiment illustrated in FIG. 3, the first ventilation valve unit 400 includes an electromagnetic ventilation switching valve 404 which is connected via a branch 406 to a line 408 which connects together the first secondary working connection 250.1 on the one hand and the first select-high valve 260 on the other hand, or the first primary service brake pressure modulator. The line 408 conducts the first redundancy brake pressure pBR1. The ventilation switching valve 404 is here configured as a 2/2-way valve 405 and is deenergized in the shut-off position shown in FIG. 3. In the energized state, it is in the passage position, which is not shown in FIG. 3, and connects the branch 406 to the vent 3. The ventilation switching valve 404 is switched from the shut-off position shown in FIG. 3 into the passage position, which is not shown in FIG. 3, by provision of the first ventilation switching signal SE1.

In the embodiment shown in FIG. 4, on the other hand, the ventilation switching valve 404 is inserted directly into the line 408 and not into a branch 406. In the embodiment shown in FIG. 4, the ventilation switching valve 404 is configured as a 3/2-way valve 409 and has a passage position and a ventilation position. In the deenergized state, it is in the passage position shown in FIG. 4 and, when the ventilation switching signal SE1 is provided, the 3/2-way valve 409 is switched into the ventilation position, in which the first secondary working connection 250.1 is connected to the vent 3.

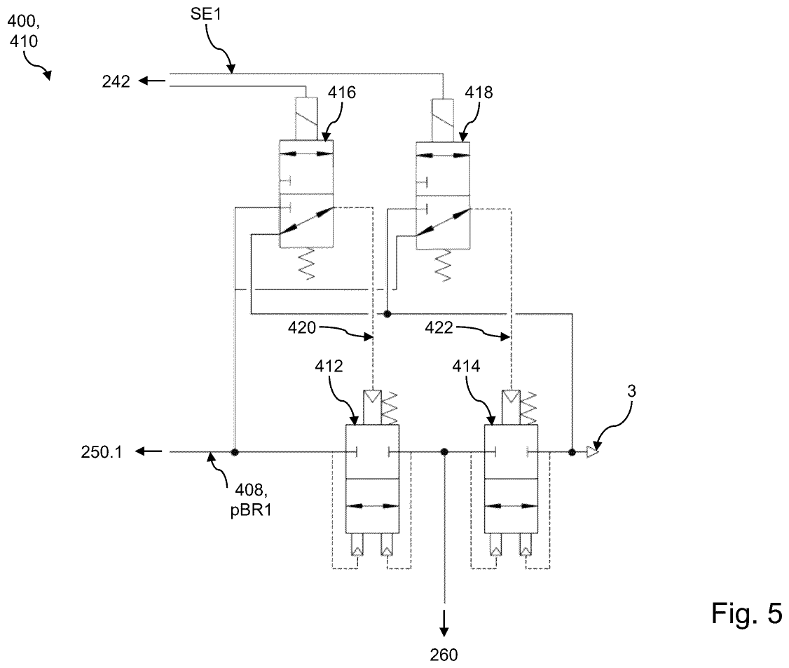

In the third embodiment of the ventilation valve unit 400 illustrated in FIG. 5, the ventilation valve unit has an ABS valve unit 410. The ABS valve unit 410 is in principle configured as known in the prior art. In the embodiment shown here, it has a pneumatically switchable inlet valve 412, a pneumatically switchable outlet valve 414, an electromagnetic inlet valve 416, and an electromagnetic outlet valve 418. The electromagnetic inlet and outlet valves 416, 418 are switchable via the first ventilation switching signals SE1 and thus also connected to the secondary electronic brake control unit 242. The electromagnetic inlet valve 416 is connected via a first control line 420 to a pneumatic control connection of the pneumatically switchable inlet valve 412, and the electromagnetic outlet valve 418 is connected via a second control line to a pneumatic control connection of the pneumatically switchable outlet valve 414. In the deenergized state, the two electromagnetic valves 416, 418 are situated in the switching position shown in FIG. 5, in which the first control line 420 is connected via the electromagnetic inlet valve 416 to the vent 3, while the pressure coming from the first secondary working connection 250.1, in particular the first redundancy brake pressure pBR1, is applied to the pneumatic control connection of the pneumatically switchable outlet valve 414 and thus likewise in the switching position shown in FIG. 5. However, when the first redundancy brake pressure pBR1 is provided, the pneumatically switchable inlet valve 412 is automatically switched via a feedback line into the switching position, which is not shown in FIG. 5, such that it is then in the passage position and the first redundancy brake pressure pBR1 can be switched through to the first select-high valve 460 or to the first redundancy connection 263. Since the second control line 422 is pressurized with this same pressure, the feedback line at the pneumatically switchable outlet valve 414 does not change the switching position, such that the vent 3 remains shut off. By contrast, if the electromagnetic outlet valve 418 is energized, pressure is no longer modulated in the second control line 422, such that, if the pneumatically switchable inlet valve 412 is open, the pneumatically switchable outlet valve 414 automatically also switches and thus connects the first secondary working connection 250.1 to the vent 3, whereby the increased air consumption described above is achieved. This can be ended by deenergizing the electromagnetic outlet valve 418 or by energizing the electromagnetic inlet valve 416.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Parking brake assembly
2 Parking brake valve unit
3 Vent
4 First reservoir connection of the parking brake valve unit
5 Second reservoir connection of the parking brake valve unit
6 Parking brake control unit
8 Relay valve
200 Electronically controllable pneumatic brake system
200a Operational level
200b First redundancy level
206 First compressed-air reservoir
210 Second compressed-air reservoir
212 Primary system
214 Primary electronic brake control unit
216 Vehicle bus
218 Unit for autonomous driving
218a Primary unit for autonomous driving
218b Secondary unit for autonomous driving
220 First supply line
222 First voltage source
224 First primary service brake pressure modulator (primary rear-axle modulator)
232.1 First service brake pressure connection
232.2 Second service brake pressure connection
236 Second primary service brake pressure modulator (primary front-axle modulator)
236.1 Third service brake pressure connection
236.2 Fourth service brake pressure connection
238a First ABS valve
238b Second ABS valve
241 Secondary system
242 Secondary electronic brake control unit
244 Second supply line
246 Second voltage source
250 First secondary service brake pressure modulator
250.1 First secondary working connection
252 Second secondary service brake pressure modulator
252.1 Second secondary working connection
254c-254f Spring brake cylinders
260 First select-high valve
262 Second select-high valve
263 First redundancy connection
264 Second redundancy connection
266 Braking value transmitter
268 Push-pull valve
280 Trailer control valve
400 First ventilation valve unit
402 Second ventilation valve unit
404 Ventilation switching valve
405 2/2-way valve
406 Branch
408 Line
409 3/2-way valve
410 ABS valve unit
412 Pneumatically switchable inlet valve
414 Pneumatically switchable outlet valve
416 Electromagnetic inlet valve
418 Electromagnetic outlet valve
420 First control line
422 Second control line
HA1 First rear axle
HA2 Second rear axle
pB1 First service brake pressure
pB2 Second service brake pressure
pBR1 First redundancy brake pressure
pBR2 Second redundancy brake pressure
pBW Braking value transmitter brake pressure
pFS Parking brake pressure
pV Reservoir pressure
SA Braking demand signals
SA-R Redundant braking demand signals
SB Service brake signals
SE1 First ventilation signal
SE2 Second ventilation signal
SFS Parking brake signal
SR Redundancy brake signals

1. An electronically controllable pneumatic brake system for a utility vehicle, the electronically controllable pneumatic brake system comprising:
at least one first service brake circuit having a first primary service brake pressure modulator for modulating a first service brake pressure at first service brake actuators at a first axle of the utility vehicle;
a primary electronic brake control unit connected via a vehicle bus to a unit for autonomous driving and configured to receive maneuver-related data from the unit for autonomous driving, wherein said primary electronic brake control unit is connected to said first primary service brake pressure modulator and provides first primary switching signals to said first primary service brake pressure modulator for switching at least one electromagnetic valve of said first primary service brake pressure modulator;
a secondary electronic brake control unit connected via the vehicle bus to the unit for autonomous driving or to a redundant unit for autonomous driving and configured to receive the maneuver-related data from said unit for autonomous driving or the redundant unit for autonomous driving, wherein said secondary electronic brake control unit is provided to control said first service brake circuit at least partially in an event of a fault of said primary electronic brake control unit;
a first secondary service brake pressure modulator connected to said secondary electronic brake control unit and configured to receive from said secondary electronic brake control unit first secondary switching signals for switching at least one electromagnetic valve of said first secondary service brake pressure modulator, wherein said first secondary service brake pressure modulator is supplied with reservoir pressure and has a first secondary working connection for providing a first redundancy brake pressure;
a parking brake assembly having a parking brake valve unit supplied with the reservoir pressure and configured to provide at a parking brake working connection a parking brake pressure for at least one spring brake cylinder of the utility vehicle;
a first ventilation valve unit arranged downstream of said first secondary working connection and connected to said secondary electronic brake control unit; and,
said first ventilation valve unit being configured to ventilate said first secondary working connection into surroundings in accordance with at least one first ventilation signal provided by said secondary electronic brake control unit so as to lower a reservoir pressure level, in order thereupon to ventilate the at least one spring brake cylinder.

2. The electronically controllable pneumatic brake system of claim 1 further comprising:
a second secondary service brake pressure modulator having a second secondary working connection for providing a second redundancy brake pressure; and,
a second ventilation valve unit arranged downstream of said second secondary working connection and being connected to said secondary electronic brake control unit or to a further electronic control unit and configured to ventilate said second secondary working connection into the surroundings in accordance with at least one second ventilation signal.

3. The electronically controllable pneumatic brake system of claim 1 further comprising a first voltage source for supplying electrical power to the primary electronic brake control unit and a second voltage source for supplying said secondary electronic brake control unit.

4. The electronically controllable pneumatic brake system of claim 1, wherein said primary electronic brake control unit is combined with said first primary service brake pressure modulator as a module to form a structural unit.

5. The electronically controllable pneumatic brake system of claim 1, wherein said secondary electronic brake control unit is combined with said first secondary service brake pressure modulator as a module to form a structural unit.

6. The electronically controllable pneumatic brake system of claim 1, wherein the first ventilation valve unit is combined with the first secondary service brake pressure modulator as a module to form a structural unit.

7. The electronically controllable pneumatic brake system of claim 1 further comprising at least one first compressed-air reservoir configured to supply said first primary service brake pressure modulator and said first secondary service brake pressure modulator with the reservoir pressure.

8. The electronically controllable pneumatic brake system of claim 7 further comprising at least one second compressed-air reservoir that supplies a second secondary service brake pressure modulator with the reservoir pressure.

9. The electronically controllable pneumatic brake system of claim 8, wherein said parking brake valve unit is supplied with the reservoir pressure from at least one of said first compressed-air reservoir, said second compressed-air reservoir, a third compressed-air reservoir and directly from an air treatment unit.

10. The electronically controllable pneumatic brake system of claim 1, wherein said first secondary working connection is connected or is configured to be connected to a first redundancy connection of said first primary service brake pressure modulator or to a second redundancy connection of a second primary service brake pressure modulator.

11. The electronically controllable pneumatic brake system of claim 2, wherein said second secondary working connection is connected or is configured to be connected to a second redundancy connection of a second primary service brake pressure modulator.

12. The electronically controllable pneumatic brake system of claim 1, wherein said first ventilation valve unit has an electromagnetic ventilation switching valve that is connected via a branch to a line leading from said first secondary working connection and that has at least one shut-off position and one passage position; in an energized state, said electromagnetic ventilation switching valve is switchable into said passage position and in a deenergized state is in said shut-off position; and, said first secondary working connection is ventilated in said passage position.

13. The electronically controllable pneumatic brake system of claim 1, wherein said first ventilation valve unit has an ABS valve unit.

14. The electronically controllable pneumatic brake system of claim 13, wherein said ABS valve unit has a pneumatically switchable inlet valve, a pneumatically switchable outlet valve, an electromagnetic inlet valve, and an electromagnetic outlet valve.

15. The electronically controllable pneumatic brake system of claim 1, wherein said first ventilation valve unit has an electromagnetic ventilation switching valve inserted into a line leading from said first secondary working connection.

16. The electronically controllable pneumatic brake system of claim 15, wherein said electromagnetic ventilation switching valve has a passage position and a ventilation position; and, in a deenergized state, said electromagnetic ventilation switching valve is in said passage position and connects said first secondary working connection to a line leading to a functional unit and in an energized state is in said ventilation position, in which said first secondary working connection is ventilated.

17. A method for controlling an electronically controllable pneumatic brake system, the electronically controllable pneumatic brake system including at least one first service brake circuit having a first primary service brake pressure modulator for modulating a first service brake pressure at first service brake actuators at a first axle of the utility vehicle; the electronically controllable pneumatic brake system including a primary electronic brake control unit connected via a vehicle bus to a unit for autonomous driving and configured to receive maneuver-related data from the unit for autonomous driving, wherein the primary electronic brake control unit is connected to the first primary service brake pressure modulator and provides first primary switching signals to the first primary service brake pressure modulator for switching at least one electromagnetic valve of said first primary service brake pressure modulator; the electronically controllable pneumatic brake system including a secondary electronic brake control unit, a first secondary service brake pressure modulator, a parking brake assembly, a first ventilation valve unit; the secondary electronic brake control unit being connected via the vehicle bus to the unit for autonomous driving or to a redundant unit for autonomous driving and configured to receive maneuver-related data from said unit for autonomous driving or the redundant unit for autonomous driving, wherein said secondary electronic brake control unit is provided to control said first service brake circuit at least partially in an event of a fault of said primary electronic brake control unit; the first secondary service brake pressure modulator being connected to the secondary electronic brake control unit and configured to receive from the secondary electronic brake control unit first secondary switching signals for switching at least one electromagnetic valve of the first secondary service brake pressure modulator, wherein the first secondary service brake pressure modulator is supplied with reservoir pressure and has a first secondary working connection for providing a first redundancy brake pressure; the parking brake assembly having a parking brake valve unit supplied with the reservoir pressure and configured to provide at a parking brake working connection a parking brake pressure for at least one spring brake cylinder of the utility vehicle; the first ventilation valve unit arranged downstream of the first secondary working connection and being connected to the secondary electronic brake control unit; the first ventilation valve unit being configured to ventilate the first secondary working connection into surroundings in accordance with at least one first ventilation signal provided by the secondary electronic brake control unit so as to lower a reservoir pressure level, in order thereupon to ventilate the at least one spring brake cylinder; the method comprising:
determining a fault that prevents a parking brake function of the electronically controllable pneumatic brake system from being actuated by ventilation of the at least one spring brake cylinder by switching of at least one electromagnetic valve of the parking brake valve unit; and,
outputting an electrical ventilation signal by a secondary electronic brake control unit to the first ventilation valve unit for the purposes of ventilating the first secondary working connection into the surroundings so as to lower the reservoir pressure level, and thereupon ventilating the spring brake cylinders.

18. A method for controlling an electronically controllable pneumatic brake system, the method comprising:
determining a fault that prevents a parking brake function of the electronically controllable pneumatic brake system from being actuated by ventilation of spring brake cylinders by switching of at least one electromagnetic valve of the parking brake valve unit; and,
outputting an electrical ventilation signal by a secondary electronic brake control unit to at least one first ventilation valve unit for the purposes of ventilating a first secondary working connection into surroundings so as to lower a reservoir pressure level, and thereupon ventilating the spring brake cylinders.

19. The method of claim 17 further comprising:
modulating a first redundancy brake pressure at the first secondary working connection at the instigation of the secondary electronic brake control unit.

20. The method of claim 18 further comprising:
increasing a pressure in one or a plurality of service brake cylinders; and
maintaining the increased pressure in the one or the plurality of service brake cylinders.

20. A utility vehicle comprising at least one front axle, at least one rear axle, and the electronically controllable pneumatic brake system of claim 1.
